(19) United States
(12) Patent Application Publication
(10) Pub. No.: US 2013/0186794 A1
(43) Pub. Date: Jul. 25, 2013

(54) TOOL STORAGE AND TRANSPORT SYSTEM

(71) Applicant: LF Centennial Ltd., Tortola (VG)

(72) Inventors: Terrence P. KINSKEY, Alpharetta, GA (US); Matthew G. WILLIAMS, Lighthouse Point, FL (US)

(73) Assignee: LF Centennial Ltd., Tortola (VG)

(21) Appl. No.: 13/796,182

(22) Filed: Mar. 12, 2013

Related U.S. Application Data
(63) Continuation-in-part of application No. 29/392,679, filed on May 25, 2011.

(51) Int. Cl. B25H 3/00

(52) U.S. Cl. CPC B25H 3/00
USPC 206/372

(57) ABSTRACT

A tool storage and transport system including a tool bag body formed from a base, a first exterior wall perpendicular to the base, and a second exterior wall perpendicular to the base and opposite the first exterior wall; and a tool organizer slidably engagable with at least one of the first and second exterior walls. The tool organizer includes a generally rectangular wall having a first end, a second end opposite the first end, a front face and a back face opposite the front face, and at least one tool receptacle extending from the front face or back face of the wall. The first end is slidably engagable with the first exterior wall.

### CROSS-REFERENCE TO RELATED APPLICATIONS

This application is a continuation-in-part of U.S. Design patent application Ser. No. 29/392,679, filed May 25, 2011, the entirety of which is incorporated herein by reference.

### FIELD OF THE INVENTION

The present invention relates generally to the field of tools, and more particularly to a system to organize, store and transport tools.

### BACKGROUND

Various tool holders are known to be useful for workers needing to organize and store or carry a group of tools or transport tools to and from a work site for a specific job. Workers often own several tool bags containing tools specific to a particular type of project, e.g., plumbing, electrical work, carpentry, masonry, etc. The need for multiple tool bags can be expensive. In conventional tool holders and bags, tools may be scattered haphazardly in a compartment or loose tools will be scattered during transport so that it may be difficult to quickly locate a specific tool at the work site. While conventional tool holders and others of the prior art are useful in some instances, there are still numerous deficiencies and the potential for more useful tool systems and features.

### SUMMARY OF THE INVENTION

A tool storage and transport system including a tool bag body and a tool organizer slidably attachable to the tool bag body is described herein. The tool bag body can be formed from a base, a first exterior wall perpendicular to the base, and a second exterior wall perpendicular to the base and opposite the first exterior wall. The tool organizer can include a generally rectangular wall having a first end, a second end opposite the first end, a front face and a back face opposite the front face and at least one tool receptacle. The at least one tool receptacle can extend from the front face or back face of the wall. The first end of the tool organizer can slidably engage with the first exterior wall. The first exterior wall can include an endwall or the first exterior all can include a side wall.

In some embodiments, the second end of the tool organizer can slidably engage with the second exterior wall. In some embodiments, the tool bag body can also include a third exterior wall perpendicular to the base and perpendicular to the first and second exterior walls, and the second end of the tool organizer can slidably engage with the third exterior wall.

The first exterior wall can include a plurality of tracks or projections and the first end of the tool organizer can engage with at least one of the tracks or projections when slidably attached to the tool bag body. The first exterior wall can include a plurality of tracks and the first end of the tool organizer can engage with two of the tracks when slidably attached to the tool bag body.

The tool organizer can also include at least one stabilizing member. The stabilizing member can be connected to the first end of the tool organizer. The stabilizing member can slidably engage with the first exterior wall. The stabilizing member can be connected perpendicular to the wall of the tool organizer. The stabilizing member can include a first vertical lip and a second vertical lip, the first exterior wall can include a first track and a second track, the first vertical lip of the stabilizing member can slidably engage with the first track, and the second vertical lip of the stabilizing member can slidably engage with the second track. The stabilizing member can also be connected to the second end of the tool organizer.

The tool storage and transport system can also include at least one auxiliary tool receptacle separate from the tool organizer. The auxiliary tool receptacle can be slidably attachable to at least one of the first and second exterior walls. At least one of the first and second exterior walls can include a plurality of tracks or projections and the at least one auxiliary tool receptacle can engage with at least one of the tracks or projections when slidably attached.

A tool storage and transport system including a tool bag body and a plurality of tool organizers is described herein. The tool bag body can be formed from a base and a plurality of exterior walls perpendicular to the base. Each of the tool organizers can be slidably attachable to the tool bag body via engagement with at least one of the plurality of exterior walls. Each of the tool organizers can include a generally rectangular wall having a first end, a second end opposite the first end, a front face and a back face opposite the front face, and at least one tool receptacle extending from the front face or back face of the wall. The first end of the tool organizer can slidably engage with at least one of the plurality of exterior walls.

The tool storage and transport system can also include at least one docking mount for storing at least a portion of the plurality of tool organizers at a location separated from the tool bag body. The at least one docking mount can be adapted for attachment to a surface separate from the tool bag body.

The docking mount can include a plurality of docking tracks and at least one of the first and second ends of the tool organizers can slidably engage with at least one of the docking tracks. The plurality of exterior walls of the tool bag body can include a first endwall, a second endwall opposite the first endwall, a first sidewall, a second sidewall opposite the first sidewall, and a plurality of tool bag tracks or projections. Each of the plurality of tool organizers can slidably engage with at least one of the tool bag tracks or projections.

The plurality of tool organizers can include at least one longitudinal tool organizer for removable attachment perpendicular to at least one of the first and second endwalls and at least one cross-sectional tool organizer for removable attachment perpendicular to at least one of the first and second sidewalls. The plurality of tool organizers can also include at least one corner tool organizer for removable attachment perpendicular to at least one of the first and second endwalls and perpendicular to at least one of the first and second sidewalls.

A method of storing and transporting tools is described herein. The method includes providing a tool bag body, providing a plurality of tool organizers, selecting at least one tool organizer from the plurality of tool organizers, and slidably attaching the at least one tool organizer into the tool bag body. The tool bag body can be formed from a base and a plurality of exterior walls perpendicular to the base. The plurality of exterior walls can include a plurality of tool bag tracks. Each of the tool organizers can include a generally rectangular wall having a first end, a second end opposite the first end, a front face and a back face opposite the front face, and at least one tool receptacle extending from the front face or back face of the wall. The first end of the at least one tool organizer can slidably engage with at least one of the plurality of tool bag tracks and at least one docking mount.

The method can also include providing at least one docking mount separate from the tool bag body and storing the at least one tool organizer at a location separated from the tool bag body. The first end of the at least one tool organizer can slidably engage with the docking mount.

These and other features, objects and advantages of the present invention will become more apparent to one skilled in the art from the following description and claims when read in light of the accompanying drawings.

### BRIEF DESCRIPTION OF THE DRAWINGS

FIG. 1 is a perspective view of a tool storage and transport system described herein.

FIG. 2 is a perspective view of a tool organizer described herein.

FIG. 3A is a perspective view of a tool bag body described herein

FIG. 3B is a perspective view of another tool bag body described herein.

FIG. 4 is a perspective view of the tool storage and transport system of FIG. 3B with a lateral tool organizer attached thereto.

FIG. 5 is a perspective view of the tool storage and transport system of FIG. 3B with a corner tool organizer attached thereto.

FIG. 6 is a perspective view of a tool storage and transport system with a tool organizer and an auxiliary tool receptacle attached thereto.

FIG. 7 is a perspective view of a tool organizer described herein.

FIG. 8 is a top view of an exterior wall and tool organizer described herein.

FIG. 9 is a top view of another exterior wall and tool organizer described herein.

FIG. 10 is a top view of another exterior wall and tool organizer described herein.

FIG. 11 is a perspective view of a tool storage and transport system described herein including a tool caddy.

FIG. 12 is a perspective view of a tool storage and transport system described herein including a tool caddy.

FIG. 13 is a cross-sectional view of the tool caddy of FIG. 12 taken along cut lines 13-13.

FIG. 14 is a perspective view of the tool storage and transport system described herein, where tool organizers are attached to docking mounts.

### DETAILED DESCRIPTION

A tool storage and transport system 10 is described herein. As shown in FIGS. 1-14, the system 10 can include a tool bag body 20 and at least one tool organizer 50 slidably attachable to the tool bag body 20. As shown in FIG. 1, the tool bag body 20 can be formed from a base 25 and a plurality of exterior walls 31, 32, 33, 34 perpendicular to the base 25. The plurality of exterior walls 31, 32, 33, 34 can include a first exterior wall 31 and a second exterior wall 32 opposite the first exterior wall 31. The plurality of exterior walls 31, 32, 33, 34 can also include third and fourth exterior walls 33, 34 opposite one another. The tool bag body 20 can also include handles 26, straps 27, and attachment members 28 for handles or straps for carrying the tool bag body 20.

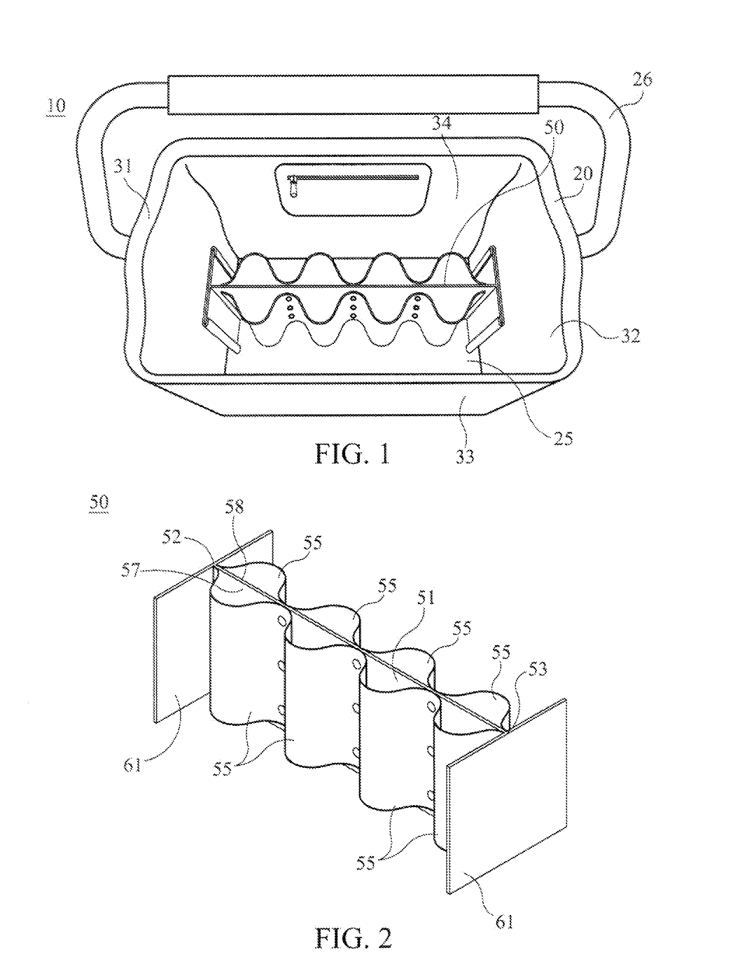

As shown in FIG. 2, the tool organizer 50 can include a first end 52, a second end 53 opposite the first end 52, and at least one tool receptacle 55. As used herein, the term “tool receptacle” refers to a receptacle configured to receive and store a tool. Tool receptacles can include without limitation sleeves, pockets, prongs, clips, compartments, subcompartments, and trays.

The first end 52 of the tool organizer 50 can slidably engage with the first exterior wall 31 of the tool bag body 20. When attached to the tool bag body 20, the tool organizer 50 can extend to the opposing exterior wall 32, only a portion of the length of the tool bag body 20, or to one or more adjacent exterior walls 33, 34. When extending to the opposing/second exterior wall 32, the second end 53 of the tool organizer can also slidably engage with the second exterior wall 32.

As shown in FIG. 2, the tool organizer 50 can include a generally rectangular wall 51 having a first end 52, a second end 53 opposite the first end 52, a front face 57 and a back face 58 opposite the front face 57. The at least one tool receptacle 55 can extend from the front face 57 or back face 58 of the wall 51.

The tool organizer 50 can also include a plurality of tool receptacles 55 extending from the front face 57, the back face 58, or both sides 57, 58 of the wall 51. The tool receptacles 55 can include the same type of receptacles or a mixture of different types of receptacles, as shown in FIG. 7.

The tool organizer 50 can be formed from suitable materials including plastics, wood, metals, polymers, fabrics, and combinations thereof. The wall 51 and tool receptacles 55 of the tool organizer 50 can be formed as a unitary piece, or as multiple attached pieces. The tool receptacles 55 can be attached to the wall 51 with fasteners such as rivets, screws, nails, staples, stitching and adhesives. The tool organizer 50 including tool receptacles 55 can also be integral, e.g., when formed by injection molding.

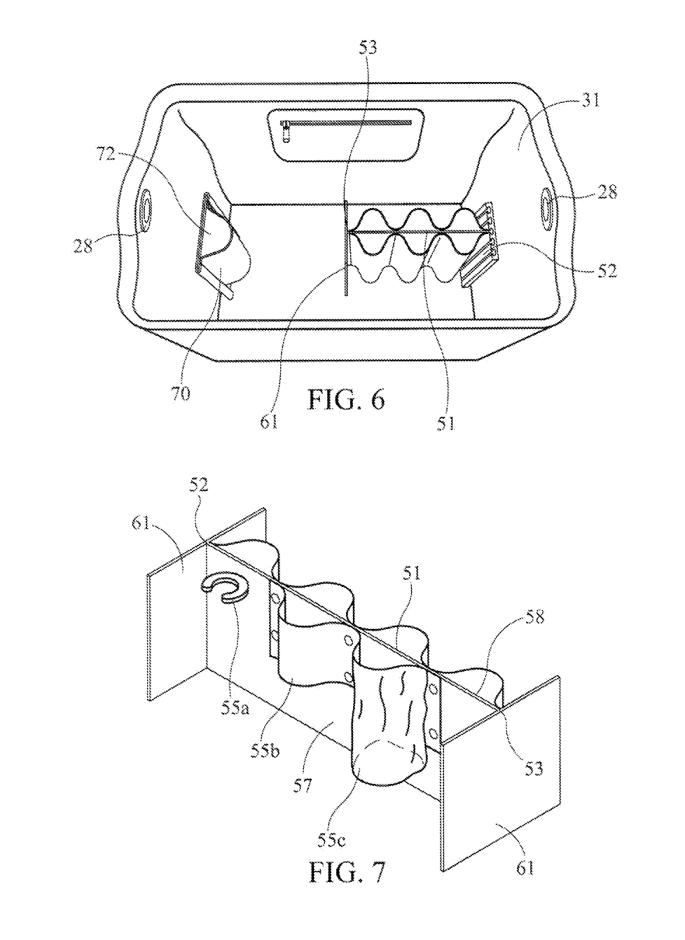

The first end 52 of the tool organizer 50 can slidably engage with the first exterior wall 31 of the tool bag body 20. The slidable engagement can be directly against the exterior wall 31 or can be via an intermediate device between the exterior wall 31 and the first end 52 of the tool organizer 50. When attached to the tool bag body 20, the wall 51 of the tool organizer 50 can extend to the opposing exterior wall as shown in FIG. 1 or only a portion of the length of the tool bag body 20, as shown in FIG. 6. In one arrangement shown in FIGS. 1 and 4, the first end 52 of the tool organizer 50 can slidably engage with the first exterior wall 31 and the second end 53 of the tool organizer 50 can slidably engage with the second exterior wall 32. The first and second exterior walls 31, 32 can be endwalls, as shown in FIG. 1, or sidewalls, as shown if FIG. 4.

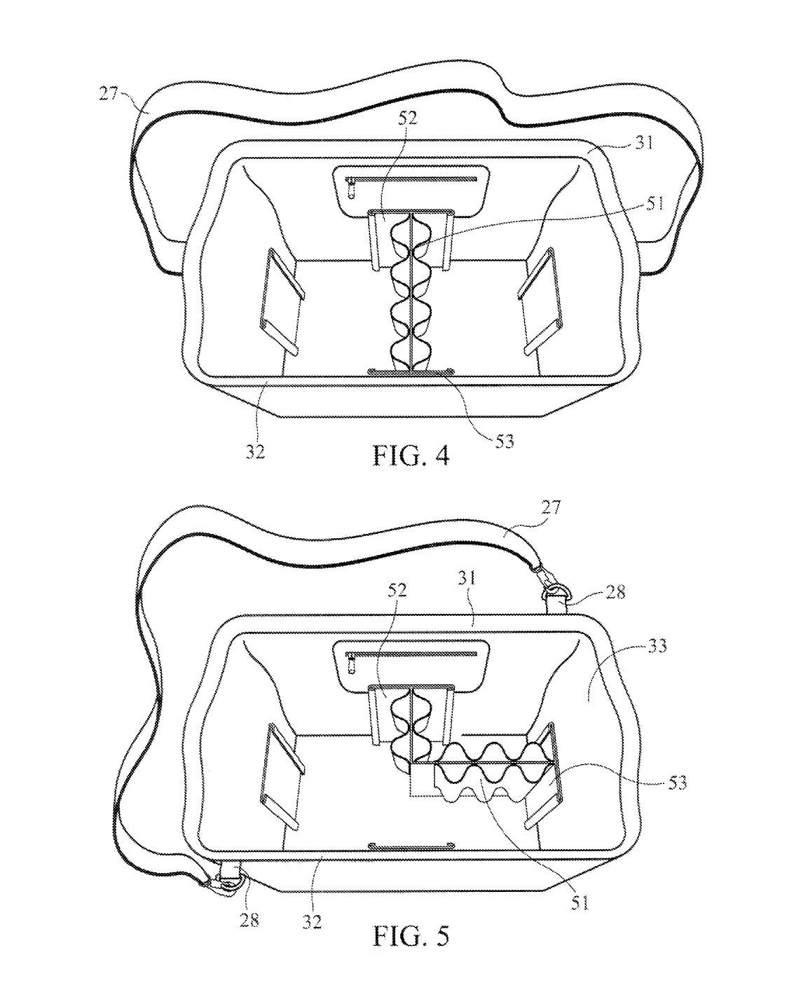

As shown in FIG. 5, the tool organizer 50 can be generally L-shaped. Where the tool organizer 50 is generally L-shaped, the first end 52 of the tool organizer 50 can slidably engage with the first exterior wall 31 and the second end 53 of the tool organizer 50 can slidably engage with a third exterior wall 33 that is perpendicular to the first exterior wall 31.

In order to facilitate the slidable attachment of the tool organizer 50 to the tool bag body 20, the tool bag body 20 can also include at least one securing mount on any of the exterior walls 31, 32, 33, 34 for slidably engaging with a corresponding structure on the tool organizer 50. The securing mounts can be coupled to an interior surface of the exterior walls 31, 32, 33, 34 and can include at least one track 40 or at least one projection 45. The exterior walls 31, 32, 33, 34 can also include a plurality of tracks 40, 41, a plurality of projections 45, or both. The first end 52 of the tool organizer 50 can also include a projection 45 or track 40 for engagement with a corresponding track 40 or projection 45 on the exterior was 31, 32, 33, 34.

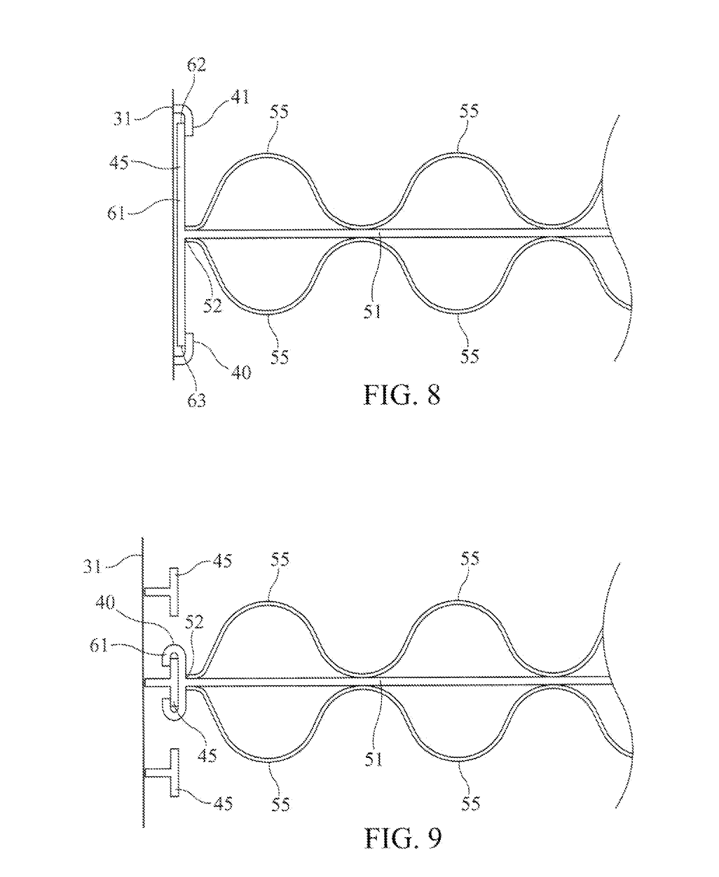

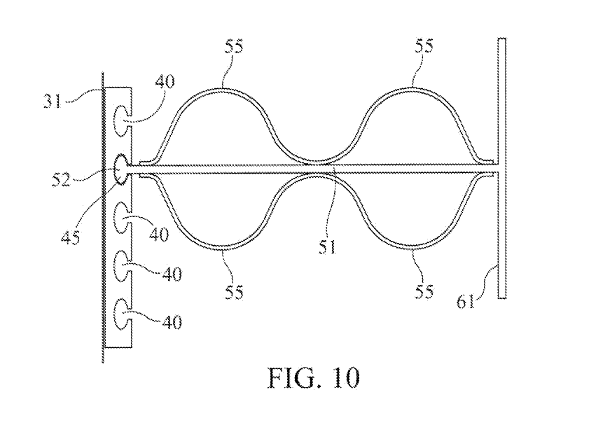

As shown in FIG. 10, the first exterior wall 31 can include a plurality of tracks 40 and the first end 52 of the tool organizer 50 can include a projection 45 that can slidably engage with at least one of the tracks 40 in order to slidably attach the tool organizer 50 to the first exterior wall 31. As shown in FIG. 8, the projection 45 of the tool organizer 50 can also engage with at least two of the tracks 40, 41 in order to slidably engage the tool organizer with the first exterior wall 31.

In one arrangement, the plurality of tracks 40 can include vertical channels integral with or attached to an exterior wall 31, 32, 33, 34. The first end 52 of the tool organizer 50 can include a corresponding projection 45 that can slidably engage with the vertical channel 40, but cannot be removed by a horizontal force as shown in FIGS. 6 and 10.

In another arrangement, the plurality of tracks 40 can include a pair of inwardly facing tracks 40, 41 and the first end 52 of the tool organizer 50 can include a corresponding projection 45 that can slidably engage with the pair of tracks 40, 41. For example as shown in FIG. 8, two of the tracks 40, 41 can include a pair of substantially L-shaped tracks positioned with the receiving portions of each track 40, 41 facing towards each other. The first end 52 of the tool organizer 50 can form a corresponding T-shaped projection adapted to slide between the pair of L-shaped tracks.

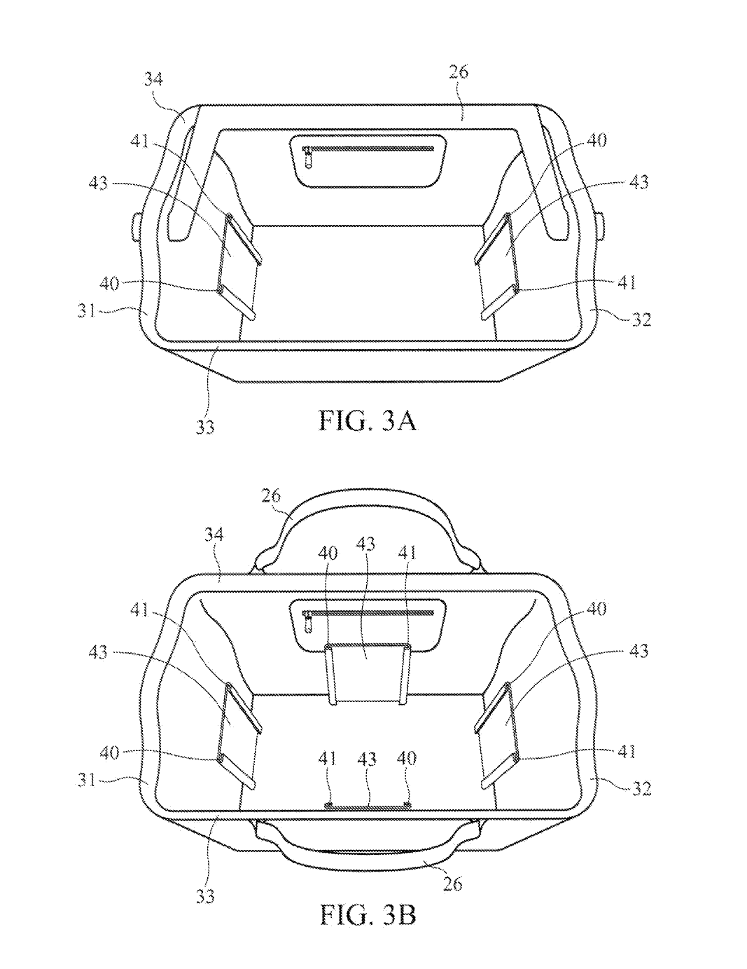

As shown in FIGS. 3A and 3B, at least one of the exterior walls 31, 32, 33, 34 can include an attachment plate 43 coupled to an inner side of the exterior all 31, 32, 33, 34. The attachment plate 43 can include a first track 40 extending along a first vertical edge of the attachment plate 43 and a second track 41 extending along a second vertical edge of the attachment plate 43. The first end 52 of the tool organizer 50 can include a projection 45 attached perpendicular to the wall 51, and the projection 45 can slidably engage with the first and second tracks 40, 41 of an attachment plate 43.

In another arrangement, a plurality of projections 45 can extend from the first exterior wall 31 to form symmetric or asymmetric engagement portions. The first end 52 of the tool organizer 50 can include a corresponding track 40 that can slidably engage with the engagement portion of a projection 45. For example as shown in FIG. 9, a projection 45 can include a substantially T-shaped engagement portion and the first end 52 of the tool organizer 50 include a corresponding C-shaped track 40 adapted to surround the distal portion of the T-shaped engagement portion 45.

The tool organizer 50 can also include at least one stabilizing member 61. As used herein, the term “stabilizing member” refers to a portion of the tool organizer providing independent support for maintaining the tool organizer 50 in an upright position when not attached to the tool bag body 20. The stabilizing member 61 can be connected perpendicular to the wall 51 of the tool organizer 50. As used herein, “perpendicular” includes 90 degrees and also minor deviations therefrom such as 75 degrees, 95 degrees, 100 degrees, and 120 degrees.

Stabilizing member(s) 61 can be connected to the first end 52 of the tool organizer 50, the second end 53 of the tool organizer 50, or both 52, 53. The stabilizing member 61 can also be connected to an intermediate portion of the wall 51. The stabilizing member 61 can be co-extensive with or separate from the projection 45 or track 40 attached to the wall 51. Alternately, the stabilizing member 61 can be integrated into a portion of the projection 40 or track 45. As shown in FIGS. 8 and 9, the stabilizing member 61 can also be connected to the first end 52 of the tool organizer 50 and form the projection 45 or track 40 that is slidably engageable with the track 50 or projection 45 of an exterior wall 31, 32, 33, 34.

The stabilizing member 61 can also be connected perpendicular to the wall 51 of the tool organizer 50 and can include a first vertical edge 63 and a second vertical edge 64. The first exterior wall 31 can include a first track 40 and a second track 41 extending into the storage space of the tool bag body 20. As shown in FIG. 8, the first edge 62 of the stabilizing member 61 can slidably engage with the first track 40 and the second edge 63 of the stabilizing member 61 can slidably engage with the second track 41.

As shown in FIGS. 6, 11 and 12, the tool storage and transport system 10 can also include one or more auxiliary tool receptacles 70 slidably attachable to an individual wall including an exterior wall 31, 32, 33, 34 or the tool wall 50. As used herein, “auxiliary tool receptacle” refers to a receptacle configured to receive and store a tool that can be removably attached to only one wall at a time. Auxiliary tool receptacles 70 are adapted to extend generally parallel to the wall to which it is attached. The auxiliary tool receptacle 70 can also include a back wall 72 and, when attached to an exterior wall, the back wall 72 can be substantially parallel to the exterior wall. The auxiliary tool receptacle 70 is configured to store a tool alongside the exterior wall to which it is attached and does not extend perpendicular or diagonally across the length of the tool bag body 20 to another exterior wall. For example, the auxiliary tool receptacle 70 can include a sleeve, pocket or other tool receptacles.

The auxiliary tool receptacle 70 can also slidably engage with at least one of the plurality of tracks 40 or projections 45 on the exterior walls 31, 32, 33, 34. Thus, the auxiliary tool receptacle 70 can be removably attached to the tool bag body 20 when the tool organizer 50 is removed or can be removably attached to any of the plurality of tracks 40 or projections 45 that are not slidably engaged with the tool organizer 50 as shown in FIG. 6.

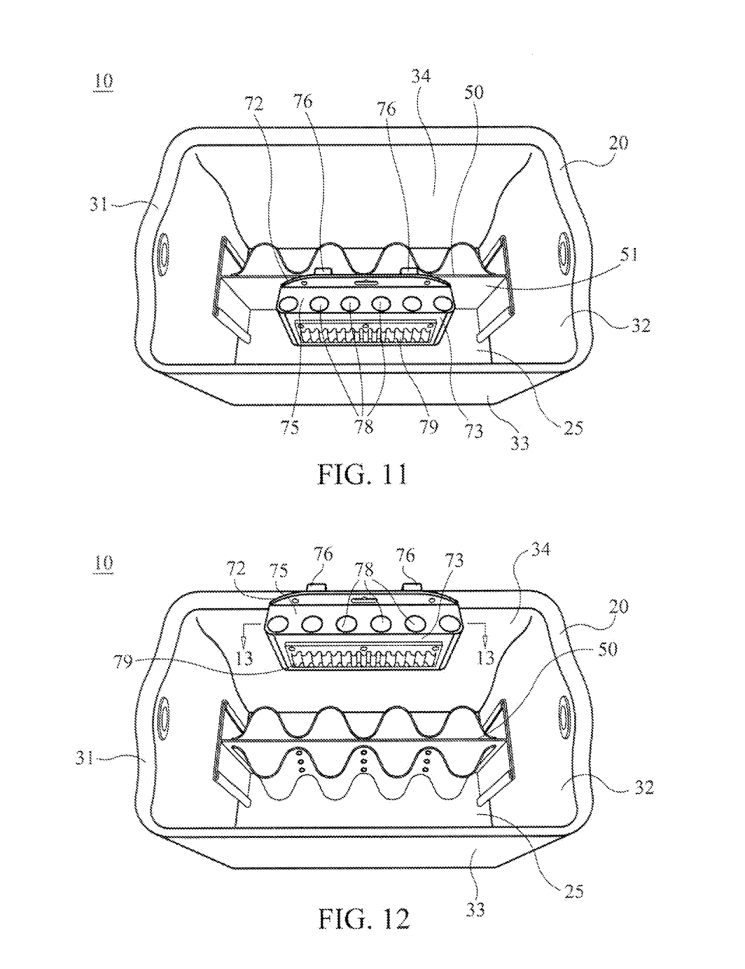

As shown in FIGS. 11-13, the auxiliary tool receptacle can also include a tool caddy 75. The tool caddy 75 can include a back wall 72 and attachment members 76 extending from the back wall 72 for attachment to a wall 51 or 34 or other surface (e.g., a tool belt, belt or waistband). The attachment members 76 can include, without limitation, cups, hooks, etc.

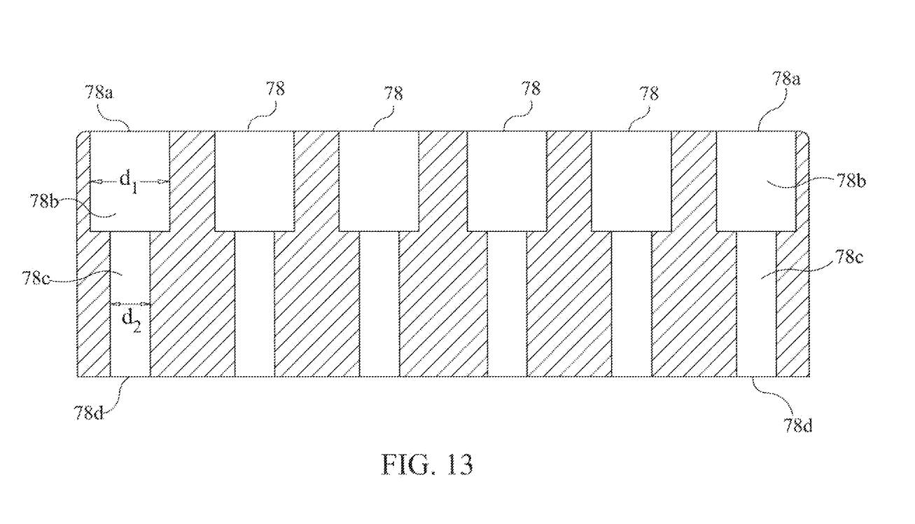

The tool caddy 75 can include various holders as shown in FIGS. 11 and 12. For example, the caddy 75 can include one or more screwdriver holders 78, one or more drill bit holders 79, other tool holders, or combinations thereof. The drill bit holders 79 can include a sleeve attached to a front wall 73 of the tool caddy 75. The sleeve can provide a plurality of drill bit holders 79. The screwdriver holder 78 can include a channel for receiving and supporting a screwdriver or similar tool, including an upper opening 78a, an upper channel section 78b and a lower channel section 78c. As shown in FIG. 13, the upper channel section 78b can have a diameter (d1) that is greater than a diameter (d2) of the lower channel section 78c. For example, the diameter d2 can be wider than the blade end and shank of a screwdriver but narrower than the handle of the screwdriver, and the diameter d2 can be wide enough to receive the handle. Accordingly, at least a portion of a screwdriver handle can rest in the upper channel section 78b and at least a portion of a screwdriver shank can rest in the lower channel section 78c when a screwdriver is stored in the screwdriver holder 78. The screwdriver holder 78 can also include a lower opening 78d at the bottom of the channel through which the blade end of a screwdriver or similar tool can pass. The tool caddy 75 can also include a plurality of screwdriver holders 78, as shown in FIGS. 11-13.

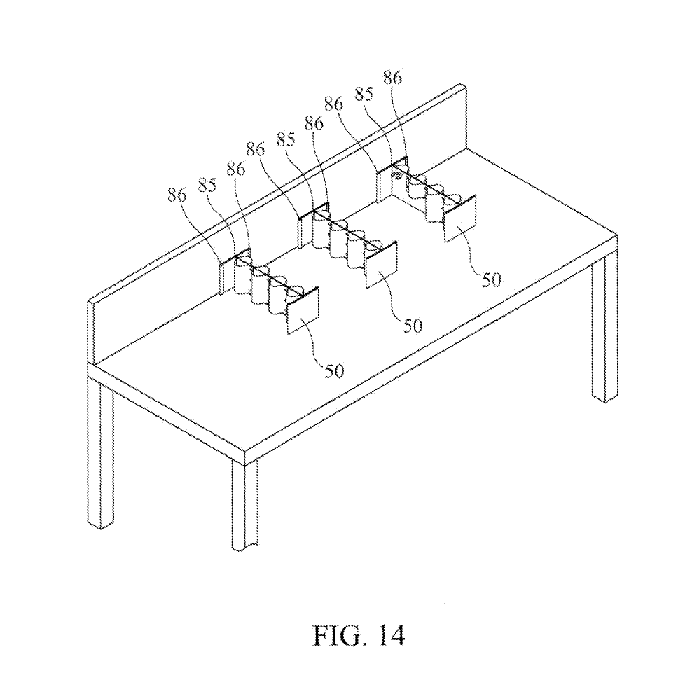

As shown in FIG. 14, the tool storage and transport system 10 can also include at least one docking mount 85 for storing at least one tool organizer 50 or auxiliary tool receptacle 70 separate from the tool bag body 20. The docking mount 85 can be adapted for attachment to a surface located remotely from the tool bag body 20, including without limitation a surface on a work bench, a surface on a storage closet or other storage container, a wall-mountable partition, or a wall. However, the tool storage and transport system 10 and the docking mount 85 need not necessarily include the surface to which the docking mount 85 will be attached.

At least one of the first and second ends 52, 53 of the tool organizers 50 can slidably engage with at least one docking mount 85, as well as, at least one projection 45 or track 40 attached to a wall 31, 32, 33, 34 of the tool bag body 20. The docking mount 85 can have a similar or different configuration than the securing mount(s) in the tool bag body 20.

In one arrangement, the docking mount 85 can include attachment portions 86 comprising docking tracks 86 that are similar to the tool bag tracks 40 and the first end 52 of each tool organizer 50 can slidably engage with either the docking tracks 86 or the tool bag tracks 40. The docking mount 85 can also include an attachment portion 86 comprising a docking projection that is similar to the tool bag projections 45 and the first end 52 of each tool organizer 50 can slidably engage with either the docking projection or the tool bag projections 45.

In another arrangement, the docking mount 85 can include attachment portions 86 that are different from the tool bag tracks 40 or projections 45. For example, if the tool bag includes tracks 40, the docking mount attachment portions 86 can include projections or tracks with a different configuration. Or if the tool bag includes projections 45, the attachment portions 86 can include tracks or projections of a different configuration.

In some arrangements, each end of the tool organizer 50 can be adapted for attachment to a different mounting structure 40, 45, 86 in a different position. For example, the first end 52 of each tool organizer 50 can slidably engage with the tool bag tracks 40/projections 45, and the second end 53 of each tool organizer 40 can slidably engage with the docking mount 85. In another arrangement, both the first and second ends 52, 53 of the tool organizer 50 can slidably engage with either the docking mount 85 or the tool bag tracks 40/projections 45.

The tool storage and transport system 10 can also include a tool bag body 20 and a plurality of tool organizers 50. The plurality of tool organizers 50 can include at least one or more longitudinal tool organizers adapted to extend perpendicular to an endwall when slidably engaged with the endwall, as shown in FIG. 1. The plurality of tool organizers 50 can also include at least one or more lateral tool organizers adapted to extend perpendicular to a sidewall when slidably engaged with the sidewall, as shown in FIG. 4. The plurality of tool organizers 50 can also include at least one corner tool organizers adapted to slidably engaged with both an endwall and a sidewall, as shown in FIG. 5. As shown in FIG. 5, the corner tool organizer can extend perpendicularly from both an endwall 31, 32 and a sidewall 33,34. The plurality of tool organizers 50 can also include any combination of longitudinal, lateral and corner tool organizers. For example, the plurality of tool organizers 50 can include at least two organizers selected from a longitudinal tool organizer, a lateral tool organizer and a corner tool organizer. Similarly, the plurality of tool organizers 50 can include at least one longitudinal tool organizer, at least one lateral tool organizer and at least one corner tool organizer.

The tool storage and transport system 10 can also include at least one docking mount 85 or a plurality of docking mounts 85 for slid ably engaging with at least one of the plurality of tool organizers 50 and/or auxiliary tool receptacles 70 at a location separate from the tool bag body 20.

The tool storage and transport system 10 can also include various combinations of tool organizer(s) 50, auxiliary tool receptacle(s) 70, and docking mount(s) 85. For example, the system 10 can include a tool bag body 20, two tool organizers 50 and one docking mount 85. In another combination, the system 10 can include a tool bag body 20, at least one longitudinal tool organizer, at least one lateral tool organizer, at least one corner tool organizer, at least one auxiliary tool receptacles 70, and at least one docking mount 85. In another combination, the system 10 can include at least two longitudinal tool organizers, at least two lateral tool organizers, at least two corner tool organizers, at least two auxiliary tool receptacles 70, and at least two docking mount 85. In other combinations, the number of docking mount 85 can equal the number of tool organizers 50 or the number of tool organizers 50 plus auxiliary tool receptacles 70.

A method of storing and transporting tools is also described herein. The method can include the steps of providing a tool bag body 20 and a plurality of tool organizers 50; selecting at least one tool organizer 50 from the plurality of tool organizers 50; and slidably attaching the at least one tool organizer 50 into the tool bag body 20. The tool bag body 20 can be formed from a base 25 and a plurality of exterior was 31, 32, 33, 34 perpendicular to the base 25, and the plurality of exterior was 31, 32, 33, 34 can include a plurality of tool bag tracks 40.

Each of the tool organizers 50 can include a generally rectangular wall 51 having a first end 52, a second end 53 opposite the first end 52, a front face 57 and a back face 58 opposite the front face 57 and at least one tool receptacle 55 extending from the front face 57 or back face 58. The first end 52 of the tool organizer 50 can slidably engage with at least one of the plurality of tool bag tracks 40 or projections 45 and a docking mount 85; or the first end 52 of the tool organizer 50 can slidably engage with at least one of the plurality of tool bag tracks 40 or projections 45 and the second end 53 of the tool organizer 50 can slidably engage with a docking mount 85. The step of inserting the tool organizer 50 can include slidably engaging the first end 52 of the at least one tool organizer 50 with at least one of the plurality of tool bag tracks 40 or projections 45. The first end 52 of the tool organizer 50 can also slidably engage with a pair of tool bag tracks 40, 41.

The method can also include the steps of providing at least one docking mount 85 separate from the tool bag body 20; and storing the at least one tool organizer 50 at a location separated from the tool bag body 20. The storing step can include slidably engaging the at least one tool organizer 50 with the docking mount 85. The method can also include removing the at least one tool organizer 50 from a tool bag body 20 prior to slidably engaging the at least one tool organizer 50 with the docking mount 85.

The at least one docking mount 85 can include docking tracks 86 and the step of storing the tool organizer 50 can include slidably engaging the first end 52 of the at least one tool organizer 50 with at least one of the docking tracks 86 or slidably engaging the second end 53 of the at least one tool organizer 50 with at least one of the docking tracks 86. The first end 52 or the second end 53 of the tool organizer 50 can also slidably engage with a pair of docking tracks 86, 86.

The unique features of this tool storage and transport system 10 provide for improved organization and efficiency in the storage and transport of tools. The system 10 allows a user to repeatedly customize the partitions and receptacles available in a tool bag body 20 for any particular tools and/or project. The system 10 also allows quick and easy organized storage of the tool organizers 50 and any auxiliary tool receptacles 70 between the tool bag 20 and the docking mounts 85. Various tool organizers 50 can be configured for specific projects, such as electrical work, plumbing, carpentry, etc. and a user can quickly and easily switch between different tool organizers as needed. Additionally, because the tool organizers 50 can include independent support via stabilizing members 61, a tool organizer 50 can be removed from the tool bag body 20 at a jobsite for more efficient access to the tools stored therein.

The foregoing is provided for purposes of illustrating, explaining, and describing embodiments of this invention. Modifications and adaptations to these embodiments will be apparent to those skilled in the art and may be made without departing from the scope or spirit of this invention.

What is claimed is:

1. A tool storage and transport system, comprising:
a tool bag body formed from a base, a first exterior wall perpendicular to said base, and a second exterior wall perpendicular to said base and opposite said first exterior wall; and
a tool organizer slidably attachable to said tool bag body, said tool organizer comprising:
a generally rectangular wall having a first end, a second end opposite the first end, a front face and a back face opposite the front face, wherein said first end slidably engages with said first exterior wall; and
at least one tool receptacle extending from said front face or back face of said wall.

2. The tool storage and transport system according to claim 1, wherein said second end of said tool organizer slidably engages with said second exterior wall.

3. The tool storage and transport system according to claim 1, wherein said tool bag body further comprises a third exterior wall perpendicular to said base and perpendicular to said first and second exterior walls,
wherein said second end of said tool organizer slidably engages with said third exterior wall.

4. The tool storage and transport system according to claim 1, wherein said first exterior wall comprises an endwall.

5. The tool storage and transport system according to claim 1, wherein said first exterior wall comprises a side wall.

6. The tool storage and transport system according to claim 1, wherein said first exterior wall comprises a plurality of tracks or projections and said first end of said tool organizer engages with at least one of said tracks or projections when slidably attached to said tool bag body.

7. The tool storage and transport system according to claim 1, wherein said first exterior wall comprises a plurality of tracks and said first end of said tool organizer engages with two of said tracks when slidably attached to said tool bag body.

8. The tool storage and transport system according to claim 1, said tool organizer further comprising at least one stabilizing member.

9. The tool storage and transport system according to claim 8, wherein said stabilizing member is connected to said first end of said tool organizer; and said stabilizing member slidably engages with said first exterior wall.

10. The tool storage and transport system according to claim 9, wherein said stabilizing member is connected perpendicular to said wall of said tool organizer and comprises a first vertical lip and a second vertical lip, wherein
said first exterior wall comprises a first track and a second track,
said first vertical lip of said stabilizing member is slidably engageable with said first track, and
said second vertical lip of said stabilizing member is slidably engageable with said second track.

11. The tool storage and transport system according to claim 8, wherein said stabilizing member is connected to said second end of said tool organizer.

12. The tool storage and transport system according to claim 1, further comprising at least one auxiliary tool receptacle separate from said tool organizer and slidably attachable to at least one of said first and second exterior walls;
wherein at least one of said first and second exterior walls comprises a plurality of tracks or projections and said at least one auxiliary tool receptacle engages with at least one of said tracks or projections when slidably attached.

13. A tool storage and transport system, comprising:
a tool bag body formed from a base and a plurality of exterior walls perpendicular to said base; and
a plurality of tool organizers, each of said tool organizers slidably attachable to said tool bag body via engagement with at least one of said plurality of exterior walls, and each of said tool organizers comprising:
a generally rectangular wall having a first end, a second end opposite the first end, a front face and a back face opposite the front face;
wherein said first end slidably engages with at least one of said plurality of exterior walls; and
at least one tool receptacle extending from said front face or back face of said wall.

14. The tool storage and transport system according to claim 13, further comprising at least one docking mount for storing at least a portion of said plurality of tool organizers at a location separated from said tool bag body, wherein said at least one docking mount is adapted for attachment to a surface separate from said tool bag body.

15. The tool storage and transport system according to claim 14, wherein said docking mount comprises a plurality of docking tracks and at least one of said first and second ends of said tool organizers slidably engages with at least one of said docking tracks.

16. The tool storage and transport system according to claim 13, said plurality of exterior walls comprising a first endwall, a second endwall opposite said first endwall, a first sidewall, a second sidewall opposite said first sidewall, and a plurality of tool bag tracks or projections, wherein each of said plurality of tool organizers slidably engages with at least one of said tool bag tracks or projections.

17. The tool storage and transport system according to claim 16, said plurality of tool organizers further comprising:
at least one longitudinal tool organizer for removable attachment perpendicular to at least one of said first and second endwalls; and
at least one cross-sectional tool organizer for removable attachment perpendicular to at least one of said first and second sidewalls.

18. The tool storage and transport system according to claim 16, said plurality of tool organizers further comprising at least one corner tool organizer for removable attachment perpendicular to at least one of said first and second endwalls and perpendicular to at least one of said first and second sidewalls.

19. A method of storing and transporting tools, comprising:
providing a tool bag body formed from a base and a plurality of exterior walls perpendicular to said base, said plurality of exterior walls comprising a plurality of tool bag tracks;
providing a plurality of tool organizers;
selecting at least one tool organizer from the plurality of tool organizers, each of said tool organizers comprising:
a generally rectangular wall having a first end, a second end opposite the first end, a front face and a back face opposite the front face;
wherein said first end slidably engages with at least one of said plurality of tool bag tracks and at least one docking mount; and
at least one tool receptacle extending from said front face or back face of said wall; and
slidably attaching said at least one tool organizer into said tool bag body, wherein said first end of said at least one tool organizer slidably engages with at least one of said plurality of tool bag tracks.

20. The method according to claim 19, further comprising:
providing at least one docking mount separate from said tool bag body; and
storing said at least one tool organizer at a location separated from said tool bag body, wherein said first end of said at least one tool organizer slidably engages with said docking mount.
